(19) United States
(12) Patent Application Publication
(10) Pub. No.: US 2006/0129456 A1
(43) Pub. Date: Jun. 15, 2006

(54) Systems and methods for processing a rebate

(76) Inventors: Jay S. Walker, Ridgefield, CT (US); James A. Jorasch, New York, NY (US); Daniel E. Tedesco, Huntington, CT (US); John M. Packes, Hawthorne, NY (US); Keith Bemer, Pittsburgh, PA (US); John B. Dickerson, New York, NY (US)

Correspondence Address: WALKER DIGITAL, 2 HIGH RIDGE PARK, STAMFORD, CT, 06905, US

(21) Appl. No.: 11/317,522

(22) Filed: Dec. 22, 2005

Related U.S. Application Data
(63) Continuation-in-part of application No. 09/505,361, filed on Feb. 16, 2000, now Pat. No. 7,006,983.

(51) Int. Cl. G06Q 30/00

(52) U.S. Cl. 705/14

(57) ABSTRACT

According to some embodiments, systems, methods, and/or articles of manufacture are associated with identifying a product associated with a first rebate, the first rebate being redeemable by mailing a predetermined document associated with the first rebate to a first entity associated with the product, determining whether a second rebate is associated with the product, wherein the second rebate is not identified by the predetermined document associated with the first rebate, offering, in the case that the second rebate is determined to be associated with the product, the second rebate to a consumer in exchange for the first rebate, and issuing the second rebate to the consumer in exchange for the first rebate. Embodiments may also or alternatively be associated with obtaining and/or altering the predetermined document, surrendered or provided by the consumer at a retailer terminal operated by a second entity, such that the consumer can no longer redeem the first rebate by mailing the document to the first entity.

### CROSS-REFERENCE TO RELATED APPLICATIONS

This application is a continuation-in-part that claims priority and benefit under 35 U.S.C. §120 to commonly owned, co-pending U.S. patent application Ser. No. 09/505,361 entitled “METHOD AND SYSTEM FOR PROCESSING A REBATE” filed Feb. 16, 2000, which issued as U.S. Pat. No. ______ on ______, the entirety of which is incorporated by reference herein.

### FIELD

Embodiments are generally related to the field of product promotions, and more particularly, to systems, methods, articles of manufacture, and apparatus for processing rebates.

### BACKGROUND

Manufacturer rebates, such as mail-in rebates, are a popular way for manufacturers to offer price reductions directly to consumers. For example, a report by Cox Direct Inc., a direct-marketing company based in Largo, Fla., indicates that seventy-six percent (76%) of surveyed packaged-goods companies used money-back offers in 1996, which has increased from sixty-six percent (66%) in 1995. In addition, NCH NuWorld Marketing Ltd., a large U.S.-based coupon processor, indicates that the use of traditional cents-off coupons is decreasing, while the manufacturer rebate business is increasing, especially for higher-priced items.

Distributor or manufacturer rebates overcome some disadvantages associated with traditional manufacturer price reductions. With traditional manufacturer price reductions, retailers may elect to leave shelf prices unchanged and keep the difference between the shelf price and the manufacturer or distributor-defined price. This eliminates the promotional value of the price cuts on the part of the manufacturer or distributor, because consumers cannot realize those discounts. Manufacturers may instead choose to utilize rebates as a means of offering price reductions directly to consumers. This is preferred because it ensures that the consumers are receiving the discount that the manufacturer wants them to receive.

Despite the rise in rebates, and their advantages over traditional price cuts, there are many deficiencies with manufacturer rebate programs. Redeeming mail-in rebates is time consuming, which often deters consumers from purchasing products with attached rebates, regardless of potential savings. Also, many rebates have associated expiration dates, which means that the rebate expires on a specific date regardless of when the product was purchased. Many consumers miss the date and as a result are ineligible to receive the rebate. Others lose the rebate or materials required by the manufacturer to be eligible for the rebate and are thus unable to redeem the rebate. Some consumers simply do not attempt to redeem mail-in rebates because they do not trust that the rebate will actually be mailed to them.

Rebates can also be problematic for manufacturers, in that any mishandling of rebate redemption can generate ill will toward the manufacturer. Telephone-based help lines may be needed to deal with problems associated with rebate redemption, which means that a manufacturer must employ service representatives. As processing costs for thousands of mail-in rebates can be expensive, many manufacturers hire outside firms to handle rebate redemptions. Fraud is also a concern for the manufacturer, especially where outside firms are retained to process the manufacturer rebates. As more entities participate in the processing of the rebates, the potential for fraud and mishandling can increase. Fraud can cost a manufacturer large amounts of money if their redemption procedures are not followed and their rebate coupons are mishandled. Thus, there exists a need for an improved rebate redemption system that will encourage consumers to purchase products with associated rebates, while minimizing rebate processing costs for a manufacturer.

### SUMMARY

Systems and methods for processing a rebate are therefore provided which overcome these and other deficiencies associated with existing manufacturer and/or mail-in rebate systems. In one embodiment, a consumer purchasing a product having an associated manufacturer's mail-in rebate may redeem the rebate at the Point-Of-Sale (POS). Products that have associated manufacturer rebates are recognized when the products are purchased, e.g., based on information stored in a rebate database. When such products are identified, terms and conditions of a POS rebate are determined. In some embodiments, the value of the POS rebate is determined based on the value of the mail-in rebate offered by the manufacturer. The value of the POS rebate may be determined by querying a server containing rebate information, such as a server operated by or on behalf of the manufacturer or retailer. The consumer is then prompted to choose whether to keep the original manufacturer's mail-in rebate, or to accept the POS rebate, along with any terms and conditions associated with the POS rebate. If the consumer decides to accept the offer of the POS rebate, in one embodiment, the consumer is issued a credit for the value of the POS rebate. For example, the POS rebate can take the form of a voucher that is printed out by a terminal at the POS and given to the consumer, or by crediting an account such as a credit card account or a bank account. The POS rebate can also be recorded on a transaction card, such as a frequent shopper card. In some embodiments, the mail-in rebate, upon being exchanged for the POS rebate, may be voided, altered, collected, not provided to the consumer, and/or destroyed or otherwise substantially prevented from being redeemed.

According to some embodiments, the manufacturer determines the terms and conditions of the POS rebate and communicates these terms and conditions to the retailer periodically. In one embodiment, the manufacturer updates POS rebates by distributing updates to a rebate database. The rebate database may be centrally managed or it may be a distributed database. By allowing the manufacturer to specify, update and modify data in the rebate database, the manufacturer is able to maintain control over the cost associated with the POS rebate throughout the promotional period, as well as the value of the rebate to the consumer.

Embodiments may generally reduce the frustration and inefficiencies associated with issuing, processing, and redeeming manufacturer and/or other mail-in rebates. Because POS rebates according to some embodiments are more efficient than manufacturer and/or mail-in rebates, consumers may be more willing to purchase a product with an associated manufacturer and/or mail-in rebate knowing that they will be offered the alternative of the POS rebate. Further, consumers will be assured that they will not lose their POS rebate, because credit information will be stored by the retailer and associated with a specific consumer.

The manufacturer will enjoy greater sales and profitability because of the increased efficiency and reduced operational cost and fraud losses associated with the system of the present invention. Further, the some embodiments will add an element of flexibility to the rebate redemption process for manufacturers, in that they will be able to adjust the terms and conditions of a POS rebate dynamically, based on redemption statistics or other criteria.

Retailers will benefit from this system in that, in certain embodiments, they are able to distribute more store credits. When a retailer distributes a store credit he can expect increased sales due to customer retention and return traffic. Additionally, the retailer may expect an amount of “breakage,” or unused credit. Retailers may also benefit by being able to tailor promotional offers that are particularly suited to their consumer demographics.

### BRIEF DESCRIPTION OF THE DRAWINGS

An understanding of embodiments described herein and many of the attendant advantages thereof may be readily obtained by reference to the following detailed description when considered with the accompanying drawings, wherein:

FIG. 1 is a block diagram illustrating a rebate processing system according to some embodiments;

FIG. 2 is a block diagram of a server according to some embodiments;

FIG. 3 is a tabular diagram illustrating an exemplary rebate database data structure according to some embodiments;

FIG. 4 is a tabular diagram illustrating an exemplary consumer database data structure according to some embodiments;

FIG. 5 is a tabular diagram illustrating an exemplary redemption database data structure according to some embodiments;

FIG. 6 is a flow diagram illustrating a method for issuing a POS rebate according to some embodiments; and,

FIG. 7 is a flow diagram illustrating a method of redeeming a POS rebate according to some embodiments.

### DETAILED DESCRIPTION

I. System Architecture

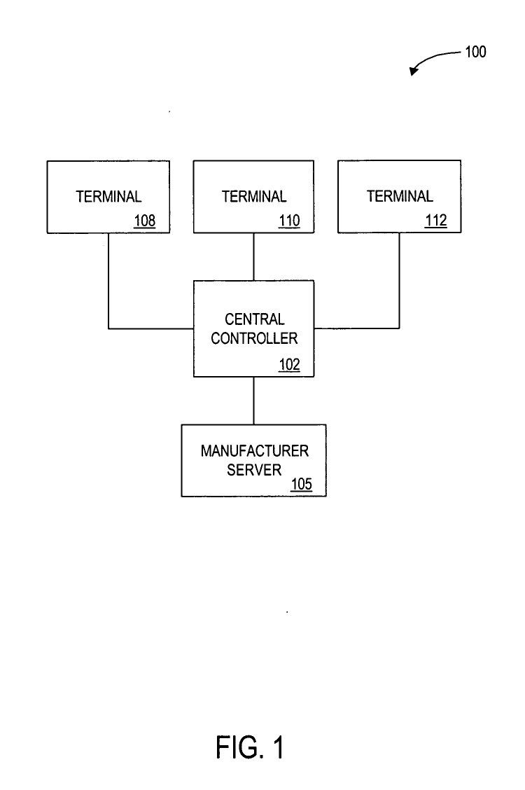

A rebate processing system 100 according to some embodiments is shown in FIG. 1. The system 100 may include, for example, a central controller 102 in communication with a plurality of terminals 108, 110, 112. The central controller 102 may also or alternatively be in communication with one or more manufacturer servers 105. The central controller 102 may communicate with the terminals 108, 100, 112 and the manufacturer server 105 directly or via an appropriate network, such as the Internet.

In one embodiment, some or all of the terminals 108, 110, 112 are retail POS terminals, such as, for example, the NCR™ 7454 terminal manufactured by NCR™ Corp. or the IBM® 4683 manufactured by IBM® Corp. or other retail terminal devices known in the art. Some or all of the terminals 108, 110, 112 and the manufacturer server 105 may comprise computers, such as those based on the Intel® Pentium® microprocessor, that are adapted to communicate with the central controller 102. In an on-line transaction, such as a transaction occurring via the Internet, some or all of the terminals 108, 110, 112 may be a computer operated at, e.g., the consumer's home or place of business acting together with, e.g., a Web server operated by or on behalf of a retailer. Further, some or all of the terminals 108, 110, 112 may comprise kiosks, hand-held computers, or any other input/output device with communications capabilities. For example, one such hand-held device is the Nino 300 Personal Companion®, manufactured by Philips™ Electronics N.V. Another example is the InfoMobile™ smart phone manufactured by Samsung Electronics™, each of which utilizes the Windows® CE operating system manufactured by Microsoft™ Corporation. Any number of the terminals 108, 110, 112 may be in communication with the central controller 102.

Communication between the terminals 108, 110, 112, the manufacturer server 105 and the central controller 102 may be direct or indirect, such as over the Internet through a Web site maintained by an entity operating the central controller 102 on a remote server or over a public or private on-line data network including commercial on-line service providers, bulletin board services, or the like. In other embodiments, the terminals 108, 110, 112 may communicate with the central controller 102 via Radio Frequency (RF), cable, satellite, or other communications links. The choice of communications interface for the central controller 102, the manufacturer server 105, and the terminals 108, 110, 112 may depend on the type of connection used. In embodiments using a network connection, the network need not be limited to any particular network protocol or topology, and may be a dedicated network or a shared network. For security and reliability reasons, a dedicated network having encryption and authentication functionality may be used.

Devices of the system 100 need not be in constant communication with each other. On the contrary, the terminals 108, 110, 112, the manufacturer server 105 and the central controller 102 need only transmit to each other as necessary, and may actually refrain from exchanging data most of the time. For example, a device in communication with another device via the Internet may not transmit data to the other device for weeks at a time.

The central controller 102 may function as a “Web server” that generates Web pages (documents on the World Wide Web that typically include a hypertext mark up language, or HTML file and associated graphics and script files) that may be accessed via the Web and which allow communication with the central controller 102 in a manner known in the art.

The system 100 may be implemented entirely or partially within a retail location, and may be entirely or partially operated by or on behalf of a retailer. In the context of the present invention, a retailer includes any entity that sells products or services. Throughout this specification, the term “product” is used to refer to products, goods and services. The term “retail location” is used to refer to both physical and remote or virtual retail sites. For example, a physical retail location may consist of a building or a portion of a building, or it may consist of a plurality of buildings, such as a chain of retail stores operating under common ownership, name, or management, for example. A virtual retail location may be one or more Web sites operated to sell goods or services. In such a case, there may not be a physical retail location, and portions of the system 100 may include a consumer's computer or software within a consumer computer. In the context of some embodiments, the term “consumer” is used to generally refer to an individual or entity who purchases a product, and the term “redeem” is used to refer to the exchange of something for value (for example, “redemption” of a POS rebate is the exchange of the POS rebate for something of value, such as a coupon, cash, a product, a discount, electronic cash, etc.).

II. Device Architecture

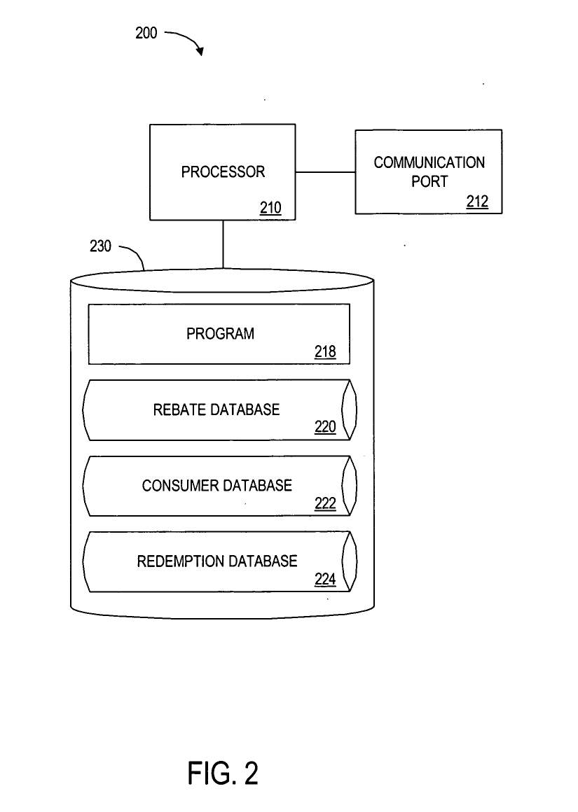

FIG. 2 is a block diagram of an exemplary embodiment of a server 200 according to some embodiments. In some embodiments, the server 200 may be similar in configuration and/or functionality to the central controller 102 of FIG. 1. The server 200 may, for example, be any computing device that can communicate with one or more other devices or terminals (such as the terminals 108, 110, 112 of FIG. 1). The server 200 may generally comprise a processor 210, such as one or more Intel® Pentium® microprocessors. The processor 210 is generally coupled to a communication port 212, through which the processor 210 communicates with other devices.

The processor 210 may also coupled to a data storage device 230. The data storage device 230 may comprise, for example, a combination of magnetic, optical and/or semiconductor memory, including Random Access Memory (RAM) and Read-Only Memory (ROM) memory units. The processor 210 and the data storage device 230 may be, for example: (i) located entirely within a single computer or other computing device; or (ii) connected by a remote communication medium, such as a serial port cable or a telephone line. In one embodiment, the server 200 may comprise one or more computers that are connected to a remote server computer for maintaining databases.

The data storage device 230 may generally store a program 218 for controlling the processor 210. The processor 210 may execute instructions of the program 218, for example, and thereby operates in accordance with one or more embodiments described herein. The program 218 may be adapted to be executed by the processor 210 and may be stored in a compressed, un-compiled, and/or encrypted format. The program 218 may also include program elements, such as an operating system, a database management system and “device drivers” that allow (and/or facilitate) the processor 210 to communicate with other devices. Appropriate device drivers and other program elements are known to those skilled in the art, and are not described in detail herein.

Methods for implementing database access by a server (such as the server 200) are well known and are continually being developed, and embodiments are not limited to the implementations explicitly described herein. Additionally, although only one server 200 (or controller) is shown in FIG. 2, the system 100 of FIG. 1 may also or alternatively consist of more than one server 102, 200 (and/or controller) or data storage device 230.

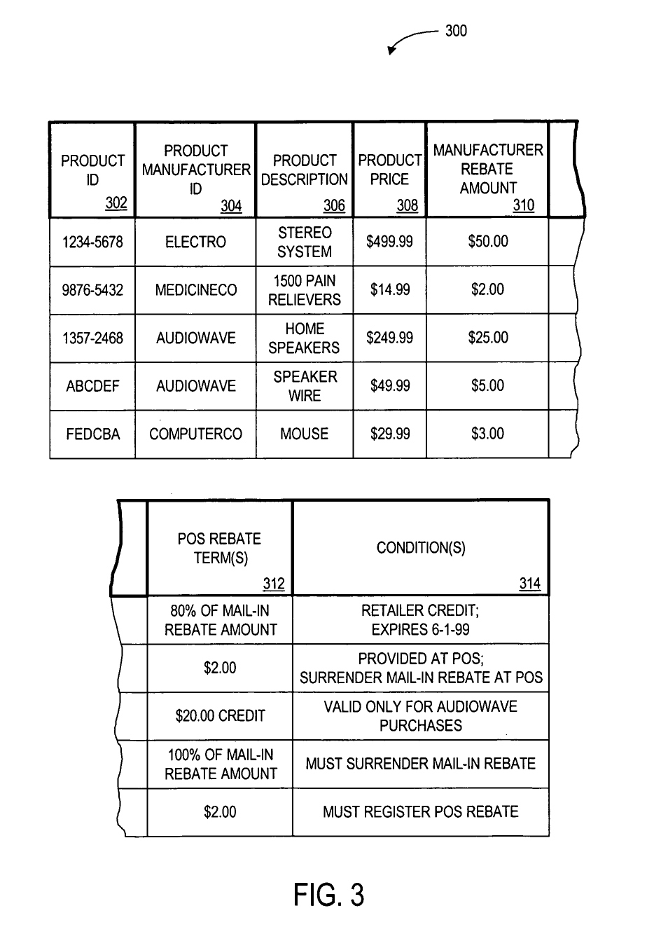

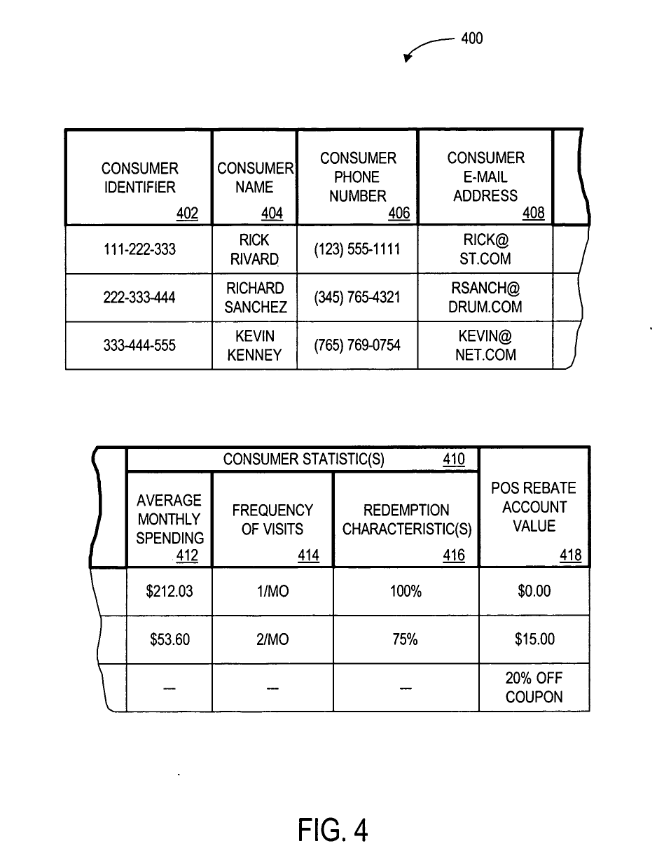

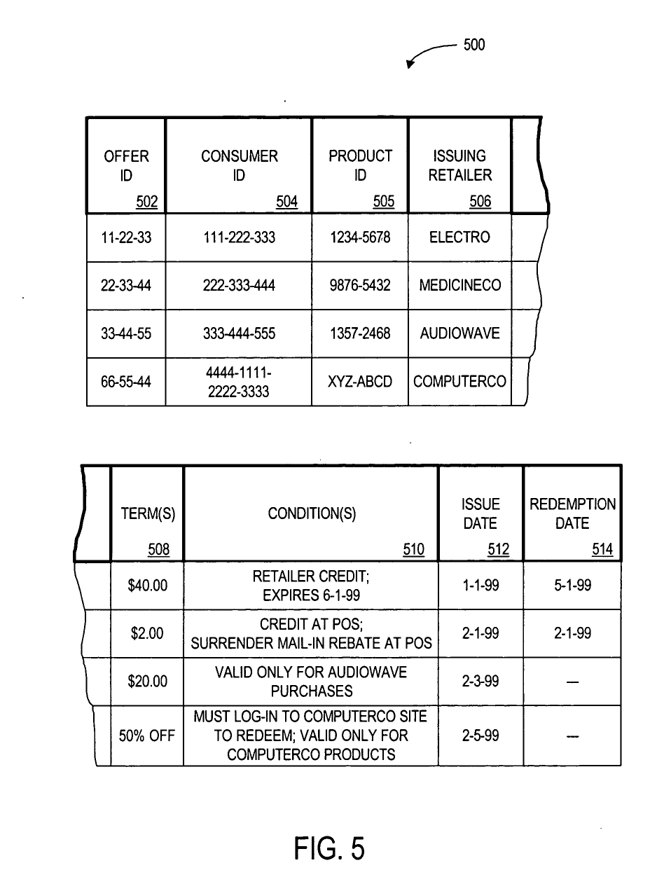

The data storage device 230 may also or alternatively store, according to some embodiments: (i) a rebate database 220, (ii) a consumer database 222, and/or (iii) a redemption database 224. The databases 220, 222, 224 are described in detail herein and are depicted with exemplary entries in FIG. 3, FIG. 4, and FIG. 5. As will be understood by those skilled in the art, the schematic illustrations and accompanying descriptions of the databases presented herein are merely exemplary arrangements for stored representations of information. Any number of other arrangements may be employed besides those suggested by the tables shown. For example, although the databases 220, 222, 224 are shown as stored in a single data storage device 230, they may be distributed between data storage devices 230. Further, some or all of the databases 220, 222, 224 may be stored locally at the terminals 108, 110, 112 of FIG. 1 and/or at the manufacturer server 105 of FIG. 1. For example, each of the terminals 108, 110, 112 may store copies of the databases 220, 222, 224 and may receive updated information from a central source, such as the central controller 102 (and/or server 200) and/or the manufacturer server 105. The illustrated entries of the databases 220, 222, 224 merely represent exemplary information, and those skilled in the art will understand that the content of these entries will vary.

III. Data Storage Structures

The data storage device 230 of FIG. 2 preferably includes: (i) a rebate database 220, which is used to identify products and associated POS rebate terms and conditions; (ii) a consumer database 222, which is used to identify consumer information; and (iii) a redemption database 224, which is used to record information on the issuance and redemption of POS rebates. Exemplary embodiments of the rebate database 220, consumer database 222, and redemption database 224, are shown in FIG. 3, FIG. 4, and FIG. 5, respectively.

A. Rebate Database

Referring now to FIG. 3, a table and/or database 300 is shown depicting sample data and fields of the rebate database 220 of FIG. 2. The table 300 preferably includes: a product ID field 302; a product manufacturer ID field 304; a product description field 306; a product price field 308; a manufacturer rebate amount field 310; a POS rebate term(s) field 312; and a condition(s) field 314. As shown in FIG. 3, some of the values in the POS rebate term(s) field 312, are values of the POS rebate expressed as a dollar amount or as a percentage of the values stored in the manufacturer rebate amount field 310. Other term(s) of the offer may also be specified as well. The condition(s) field 314 may be included, for example, to inform the consumer how the POS rebate will be processed, and what condition(s) must be met in order to redeem the POS rebate. Multiple sets of the POS rebate term(s) field 312 and/or the condition(s) field 314 may be provided to define terms and conditions of multiple POS rebates.

B. Consumer Database

In FIG. 4, a table and/or database 400 is shown depicting example data and fields of the consumer database 222 of FIG. 2. Each of the records of the table 400 preferably include: a consumer identifier field 402; a consumer name field 404; a consumer phone number field 406; a consumer e-mail address field 408; consumer statistic(s) 410; and/or a POS rebate account value field 418. As shown in table 400, the consumer statistic(s) 410 can include information such as: an average monthly spending field 412; a frequency of visits field 414; a redemption characteristic(s) field 416; etc. As a new record for a consumer is created, data identifying the consumer may be stored in the consumer identifier field 402. This consumer identifier may be, e.g., a unique number generated by the controller 102, 200, or may be data provided by the consumer such as a credit card number, a debit card number, a social security number, a telephone number, a frequent shopper number, or the like.

The POS rebate account value field 418 is an optional field which may store a cumulative amount of value that has been credited to, but not yet used by, the consumer identified by the value in the consumer identifier field 402. According to some embodiments, this information is used to establish or to further refine the value of POS rebates as is discussed in further detail elsewhere herein.

A number of consumer statistics may also be tracked and used to establish or refine POS rebates. For example, a rebate redemption rate (not shown) may be tracked. For example, if the consumer has a history of redeeming every POS rebate every time, the consumer may be offered a dollar-for-dollar POS rebate every time. Another consumer that never returns rebates to the manufacturer may be offered a POS rebate having a value equal to, e.g., eighty-five percent (85%) of the value of the manufacturer rebate. Thus, the value of a particular POS rebate may be lower than other POS rebates on the same product, and may have an associated condition that the consumer's redemption rate (or redemption behavior) be above a certain threshold value to qualify for that particular POS rebate. If the condition is not satisfied, that POS rebate is preferably not presented to the consumer.

Alternatively, the opposite may occur. For example, before a POS rebate is offered to a consumer, the consumer's record from the consumer database 222, 400 may be queried to determine the consumer's rebate redemption rate. If the consumer has a history of redeeming every rebate every time, the consumer may not be offered a dollar-for-dollar POS rebate, but may be offered a POS rebate valued at a percentage of the manufacturer rebate, such as eighty percent (80%). Another consumer who never returns rebates to the manufacturer may be offered one hundred and twenty percent (120%) of the original manufacturer rebate value. This may be an incentive for the consumer to accept the POS rebate rather than redeeming the manufacturer rebate.

C. Redemption Database

In FIG. 5, a table and/or database 500 is shown depicting sample data and fields of the redemption database 224 of FIG. 2. The records of table 500 preferably include: an offer ID field 502; a consumer ID field 504 (preferably the same as or corresponding to the consumer identifier field 402 of FIG. 4); a product ID field 505 (preferably the same as or corresponding to the product ID field 302 of FIG. 3); an issuing retailer field 506; a term(s) field 508; a condition(s) field 510; an issue date field 512; and/or a redemption date field 514. In one embodiment, records of the database 224, 500 are populated with data when a POS rebate is generated for or issued to a consumer.

The values in the offer identifier field 502 may be generated when a consumer is issued a POS rebate (e.g., when the consumer accepts an offer to exchange a manufacturer rebate for a POS rebate). This identifier may be, e.g., a number or a set of alphanumeric characters selected to uniquely identify each POS rebate. The values of the consumer identifier field 504 are preferably the same as, or related to, the values of the consumer identifier field 402 of the consumer database 222, 400 and are used to identify the consumer who has received the POS rebate. In some embodiments, e.g., where a consumer wishes to remain anonymous and the manufacturer and retailer allow anonymity, no consumer identifier value or other consumer identifying information need be provided or stored. A product identifier is generally provided in the product ID field 505. This product identifier may be the same as or related to the product identifier stored in the product ID field 302 of FIG. 3 and may be used to associate a particular offer with a particular product. Information may also be provided to identify a value of the issuing retailer field 506 of the POS rebate.

The issuing retailer field 506 may include, for example, a name of the retailer, and/or may also include more detailed identifying information such as an address of the retailer and the like. The values in the term(s) field 508 and the condition(s) field 510 of the POS rebate corresponding to the value of the offer identifier field 502 may also be included in the redemption database 224, 500. This information defines, e.g., the value of the POS rebate as well as any requirements that must be fulfilled to receive the value of the offer. These terms and conditions of the term(s) field 508 and the condition(s) field 510 may be identical to the terms and conditions of the POS rebate term(s) field 312 and the condition(s) field 314 of FIG. 3, or they may be different based on, e.g., modifications made by the retailer. For example, a retailer may choose to add an additional value term to the offer.

An issue date of the POS rebate is also included in the issue date field 512 of the redemption database 224, 500 to record the date on which the consumer received and accepted the POS rebate identified by the corresponding value of the offer identifier field 502. This may be used as a reference to determine whether the offer has expired and also to track the number of outstanding POS rebates which have been issued. Expiration information may be stored at individual POS terminals, at a central manufacturer server, etc. Further, an expiration date of an offer may be provided as a term or condition of the offer.

A redemption date may also be provided in the redemption date field 514. The redemption date field 514 may generally remain empty (or otherwise indicate a status of “NOT REDEEMED”) until the POS rebate identified by the corresponding value of the offer identifier field 502 has been associated with redemption. This is used to ensure that a POS rebate is not redeemed more than once. The redemption database 224, 500 may include other fields and information as needed to track outstanding and issued POS rebates.

The database records of the product database 220, 300, the consumer database 222, 400, and the redemption database 224, 500 may be maintained as separate tables within a single database program. Those skilled in the art will recognize that a number of different types of database arrangements and designs may be used.

IV. Processes

The flow diagrams and associated methods or processes described herein do not necessarily imply a fixed order to the actions, and embodiments may be performed in any order that is practicable. Note that any of the methods or processes described herein may be performed by hardware, software (including microcode), firmware, or any combination thereof. For example, a storage medium may store thereon instructions that when executed by a machine result in performance according to any of the embodiments described herein. In some embodiments, processes and/or methods may be performed by, facilitated by, and/or otherwise associated with the various systems and/or devices described herein. For example, the methods of some embodiments may be associated, at least partially with, the system 100 of FIG. 1, a server and/or controller (such as the central controller 102 of FIG. 1, the manufacturer server 105 of FIG. 1, and/or the server 200), and/or a terminal 108, 110, 112 of FIG. 1.

A. POS Rebate Issuance

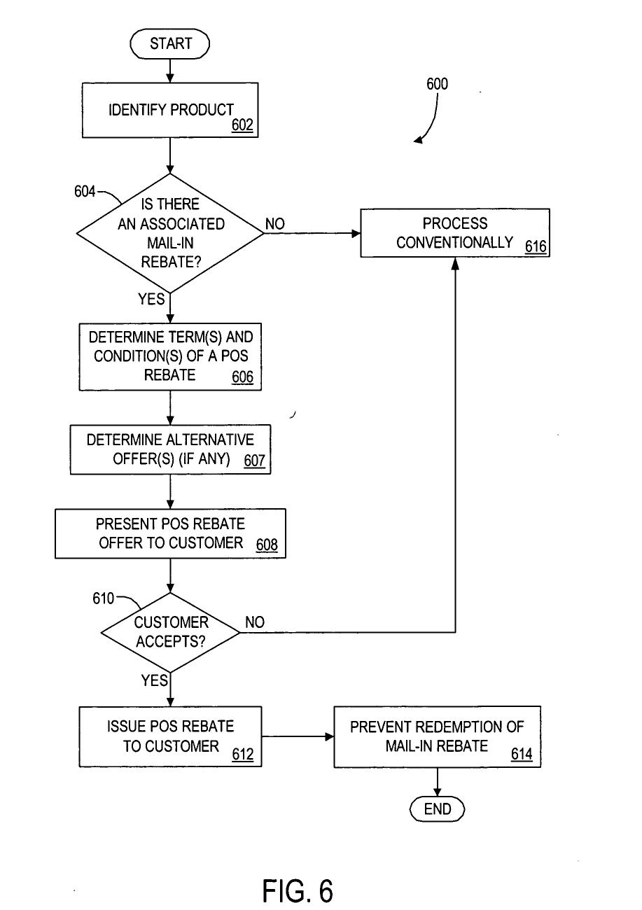

A method 600 for issuing a POS rebate according to some embodiments is shown in FIG. 6. In one embodiment, the method 600 is conducted at a retail POS (e.g., at a retail check-out counter and/or a terminal 108, 110, 112 of FIG. 1). Alternatively, or in addition, this process may be partially or wholly conducted over a network (e.g., by interacting with a Web-based merchant from a consumer's desktop computer over the Internet).

The method 600 (e.g., issuing a POS rebate) may, according to some embodiments, begin by identifying a product for purchase, at 602. This product identification may be performed in a number of ways known to those skilled in the art such as, for example, part of a scanning operation. In a retail embodiment, for example, a bar code and/or a Universal Product Code (UPC) printed on or associated with the product or product packaging may be scanned by a laser scanner or other reading device in communication with a terminal 108, 110, 112 to identify the product. Reference to a database may be made to match the product's UPC code to other product characteristics, such as the product identifier, product manufacturer, description, or price, for example. Alternatively, the product identifier stored in the product ID field 302 of the rebate database 220, 300 may be or include the UPC code. Products can be identified by referring to product information stored at the terminal 108, 110, 112, or the product identification can be made by referring to product information stored at the central controller 102 and/or the manufacturer server 105.

In one embodiment, the product may be identified from a manufacturer and/or mail-in rebate coupon accompanying the product (and/or provided by the consumer), and input to a terminal 108, 110, 112. For example, the mail-in rebate coupon may have a bar code or other machine-readable indicia that may be scanned or otherwise read at the POS to identify the product. Product identification may also be performed by means other than scanning, such as by a store clerk looking at a product label to locate a product identifier, and inputting the identifier into a terminal 108, 110, 112. In an online product purchase, product identification may be performed by the consumer selecting a product shown on a Web screen, and/or selecting to put the product into his/her virtual shopping cart, for example. Such techniques for identifying products are known to those of ordinary skill in the art.

Once the product has been identified, the product identifier (stored in the product ID field 302 of the rebate database 220, 300) is used to retrieve information regarding the product. This information is first used to determine whether the product has an associated manufacturer rebate, at 604, and is also used to determine details about the terms and conditions of the manufacturer rebate. For example, the amount of the manufacturer rebate (stored in the manufacturer rebate amount field 310 of the rebate database 220, 300) is retrieved. If the product does have an associated manufacturer rebate, the information is then used to assist in determining the terms and conditions of a POS rebate, at 606. The POS rebate preferably includes at least one term identifying the value of the POS rebate. The value of the POS rebate indicates, for example, the benefit that the consumer may elect to receive in lieu of the manufacturer's rebate (e.g., the amount of cash, the amount of credit, the type of product, or other value).

The terms and conditions of the POS rebate may be determined locally (e.g., at the POS terminal) or by reference to remote sources of information (e.g., by querying a database at a server maintained or operated on behalf of the manufacturer). For example, during checkout, a terminal, such as terminal 108, 110, 112 of FIG. 1, may be used to cause a server to access a database to determine whether a manufacturer rebate exists for the product, and the amount of credit that the manufacturer is currently offering consumers for the rebate (e.g., the current value of the manufacturer and/or mail-in rebate). By accessing or otherwise receiving information from the database, the terminal 108, 110, 112 can determine the value of the POS rebate from the POS rebate term(s) field 312, and any associated condition(s) from the condition(s) field 314. Alternatively, or in addition, the terminal 108, 110, 112 may cause the manufacturer server 105 to retrieve this information.

In one embodiment, each manufacturer is able to vary the terms and conditions (e.g., the value of the POS rebate and any redemption conditions, etc.) of POS rebates based on factors such as: available inventory for the product associated with the manufacturer's rebate, the expected breakage for the rebate program, the number of manufacturer rebates that have been redeemed, expected new product introduction dates, etc. In this manner, the manufacturer can dynamically manage inventory and control the amount of money it pays out for each POS rebate on a product-by-product basis, thereby giving the manufacturer greater control over the cost of a given promotion. The manufacturer can do this substantially in real-time, for example, by establishing the terms and conditions associated with a POS rebate each time a product having a manufacturer rebate is identified. The manufacturer can do this on a periodic basis, for example, by establishing the terms and conditions of POS rebates for particular products hourly, daily, weekly, or on some other non real-time schedule.

In one embodiment, the value of the POS rebate is calculated by retrieving the value from the manufacturer rebate amount field 310 and modifying it based on the values stored in the POS rebate term(s) field 312. For example, the value of a POS rebate may be eighty percent (80%) of the value of the manufacturer rebate. Alternatively, the value of a POS rebate may simply be determined at the POS device (e.g., a manufacturer rebate coupon may indicate the value of the offer if accepted as a POS rebate rather than as a mail-in rebate).

In another embodiment, the value of the POS rebate may consist of several different types of values. For example, a consumer may be offered a POS rebate which includes an instant credit (e.g., five dollars ($5.00) at the POS) and a future credit (e.g., a five dollar ($5.00) store credit for future purchases). Other combinations may be similarly constructed.

A number of conditions may be established, at 606 such as, for example: a requirement that the consumer sign and turn in the manufacturer rebate at the time of purchase, a requirement that the POS rebate be redeemed within thirty (30) days, and/or a restriction that the POS rebate only be used for store credit at a particular retailer.

Other terms and conditions of the POS rebate may also or alternatively be calculated or determined, at 606. For example, a manufacturer may choose to reward individual consumers based on their “value” as determined by purchasing statistics and/or demographics. The manufacturer and/or retailer may retain consumer statistics and/or demographics of individual consumers (e.g., purchasing histories). For example, this information may be used to provide a POS rebate with increased value to an established consumer or to a repeat buyer of the manufacturer's products (e.g., a consumer that initiates a subscription to a manufacturer's products). In some embodiments for example, consumers from a certain geographic region and/or defined by another demographic (e.g., income level) may be targeted for mail-in rebate and POS rebate exchanges by offering higher values for the alternative POS rebate than other customers may receive. In some embodiments, only certain demographically defined consumers may even be presented with the option to exchange a mail-in and/or manufacturer rebate for a POS rebate. Similarly, the conditions associated with and/or the type of POS rebate offered may be determined based at least in part on consumer demographics. Some consumers may be offered an instant cash rebate at the POS in exchange for the mail-in rebate (and/or document associated therewith), for example, while other consumers may be offered an alternate product, loyalty and/or reward points (e.g., frequent flyer miles), etc.

Processing, at 606, may also or alternatively include some determination or calculation of terms and conditions imposed by the retailer. For example, the value of the POS rebate may also be established based on the “value” of the consumer to the retailer. That is, certain consumers exhibiting desired behavior such as repeat business, high frequency of visits, high dollar volume, etc., may be offered higher-valued POS rebates, or POS rebates with fewer restrictions. Alternatively, shoppers who tend to spend less money or shop less frequently can be offered higher valued POS rebates to encourage them to shop more. Further, a retailer may specify an additional and/or alternate POS rebate having specific conditions that the consumer must meet to be eligible for the offer (e.g., the consumer must have a certain purchasing history, as described herein). In some embodiments, such as in the case that the POS rebate value may generally only comprise a percentage of the mail-in rebate value, a third party may “bridge the gap” between the values to motivate the consumer to exchange the mail-in rebate for the POS rebate. A credit card company and/or other sponsor may make up the difference in values, for example, if the consumer signs up for and/or utilizes the credit card company's card in making the purchase. According to some embodiments, the consumer may “name there own value” desired for the POS rebate, and third parties may determine conditions under which they would be willing to match the difference to meet the consumer-defined price.

Another condition that may be established is that the original manufacturer rebate certificate must be surrendered to the retailer. That is, consumers may be required to surrender their original mail-in rebate and proof of purchase to redeem a POS rebate. This prevents a consumer from accepting and redeeming a POS rebate, and also redeeming the manufacturer's rebate coupon with the manufacturer (i.e., prevents consumers from redeeming both the mail-in and POS rebate). A consumer may also be prevented from redeeming both rebates by requiring the consumer provide their address when selecting the POS rebate. This information can then be used to inform the manufacturer so that the manufacturer will not issue a manufacturer rebate check to that particular individual. Other restrictions and/or requirements associated with a mail-in and/or manufacturer rebate document or coupon may also or alternatively be implemented. A condition may comprise, for example, that the mail-in rebate document be stamped, hole-punched, and/or otherwise altered to prevent mail-in redemption. In some embodiments, such as in the case that the mail-in and/or manufacturer rebate is to be provided to the consumer at the POS (e.g., as part of a product or purchase receipt), a condition may be that the mail-in rebate document not be provided to the consumer (e.g., another way of preventing mail-in redemption).

In a further embodiment, the terms and conditions of a POS rebate may be determined without further input from the product manufacturer. For example, terms and conditions of POS rebates may be pre-established and stored in the database 220, 300. In this embodiment, the retailer may act as a rebate processor for manufacturer, mail-in, and POS rebates. For example, the terms and conditions of the POS rebate may be the same as the terms and conditions of the manufacturer and/or mail-in rebate. The consumer may be inclined to take the POS rebate because it will be instantly issued at the POS. In this embodiment, the retailer may pre-arrange to pass on a percentage of the full manufacturer rebate to the manufacturer. In this example, the pre-arranged percentage can be a set term in the rebate database 220, 300. For example, a retailer and manufacturer may agree in advance that the manufacturer will absorb only fifty percent (50%) of the full manufacturer rebate for the offers that are processed by the retailer. This reduces uncertainty of the manufacturer regarding redemption rates through the retail operation, while still allowing the terms of the manufacturer rebate to be presented to the consumer. This saves the manufacturer some of the costs of fulfillment. In addition, the retailer may add store credits or other additional incentives to either the manufacturer's rebate, or to the POS rebate in order to retain and/or attract consumers.

In one embodiment, the retailer may establish a value of the POS rebate based on transaction information. For example, during a checkout, a retailer may first identify that a POS rebate is available for a product being purchased. The retailer may establish the value of the POS rebate by first determining the total transaction value for the checkout. For example, if the total transaction value is eleven dollars and forty-three cents ($11.43; before any rebate), and the transaction includes a product that has a one-dollar ($1.00) manufacturer rebate, the retailer may establish a POS rebate offer value of forty-three cents ($0.43) on the theory that the consumer may be attracted to accept a rounded price. Other factors and considerations may also be used by the retailer in establishing a value for POS rebates according to embodiments. Instead of or in addition to a consumer's total retail purchase amount, for example, the value (and/or conditions) of the POS rebate may be based upon one or more items in addition to the product associated with the mail-in and/or manufacturer rebate that the consumer is purchasing. In an online and/or retail embodiment, for example, the contents of a consumer's “shopping cart” may be utilized to determine, at least in part, the value and/or conditions of a POS rebate offered to the consumer. In the case that another product is from the same manufacturer as the rebate product, for example, the POS rebate value may be higher, to encourage consumers to purchase multiple products from the same manufacturer. Such an incentive may, of course, be at least partially funded and/or encouraged by the manufacturer.

In certain embodiments, a retailer may give the consumer a choice between alternative POS rebates by determine or establish alternative offer(s) for the consumer, at 607. The retailer may utilize the POS rebate as a mechanism to generate alternative offers for consumers. For example, in one embodiment, the retailer may present an alternative product to the consumer in exchange for surrender of the manufacturer rebate coupon. As an example, if a consumer has a manufacturer rebate coupon valid for ten dollars ($10.00) off the purchase of a certain product, the retailer may present the consumer with an option to take a product in lieu of the ten-dollar ($10.00) rebate. In this way, a retailer can utilize POS rebates to manage inventory (e.g., by moving distressed inventory).

Alternatively, the retailer may allow the consumer to specify some terms and conditions of the desired rebate, such as the selection of a product category (e.g., electronics, tools, etc.) for which the rebate may be used, or an amount of money. The retailer may then determine whether it can offer any rebates meeting those conditions. Further, as described herein, one or more third-parties may be allowed to determine whether they will contribute funds to meet the consumer-defined price and/or conditions, such as in exchange for the consumer signing up for a magazine subscription, credit card, or the like.

Once the terms and conditions of the POS rebate have been established and any alternative(s) presented, the POS rebate is presented to the consumer, at 608. The POS rebate may be presented to the consumer in a number of ways, for example, by displaying the offer on a terminal screen, by printing the offer on a receipt or coupon, by displaying the offer to a retail employee who recites the POS rebate to the consumer, or in the case of an on-line purchasing session, by displaying the POS rebate on the consumer's computer screen. In one embodiment, the POS rebate is presented to a consumer by printing the offer on a receipt. The receipt is then presented to redeem the POS rebate. Alternatively, the POS rebate may be presented orally to the consumer by a device having synthesized or recorded speech characteristics, for example. The consumer may then be prompted to choose whether to keep the original manufacturer's rebate, or to have the determined value of the POS rebate issued to the consumer. In an Internet embodiment, for example, a “pop-up” dialog box may prompt the consumer for a selection.

At 610, the consumer may choose to either accept the POS rebate (e.g., choose the terms and conditions of the POS rebate instead of the terms and conditions of the manufacturer and/or mail-in rebate) or to decline it (e.g., choose to keep the manufacturer and/or mail-in rebate rather than accept the POS rebate). The consumer's selection between the manufacturer rebate and the POS rebate is input into the rebate processing system. This input may be made into a terminal by keying the selection into a keypad, speaking the selection into a voice-activated device, or touching appropriate fields within a touch screen, for example. In an online product purchase, the consumer input may be accepted from a consumer by using a dialog box on a Web browser screen, for example. If the consumer declines the POS rebate, the transaction is processed conventionally, at 616. For example, for a mail-in manufacturer rebate, the consumer must mail in the rebate to redeem it. In some embodiments, the decline of the POS rebate may allow and/or trigger the printing of the manufacturer and/or mail-in rebate (and/or indicia thereof) on a receipt and/or other document to be provided to the consumer. The receipt for the purchase of the rebate-related product, for example, may be appended and/or printed to include an indication of the mail-in rebate that may then be utilized by the consumer to mail-in to receive the manufacturer rebate for the product. In the case that the consumer accepts the exchange, such an indication of the manufacturer and/or mail-in rebate may not be printed on the receipt and/or may otherwise not be provided to the consumer.

In accordance with some embodiments, the consumer may be presented with more than one POS rebate offer depending upon a number of factors. For example, a second POS rebate may be presented if one or more predetermined conditions are met. That is, a second POS rebate may be associated with the product, and may indicate a higher-valued POS rebate if the consumer presents a predetermined product or group of products for purchase. The predetermined product(s) may be a related product from the same manufacturer. For example, a POS rebate for a stereo system may have a higher value if the consumer is also purchasing speakers from the same manufacturer. In this manner, the manufacturer can encourage the purchase of certain products associated with the initial product selected for a POS rebate promotion. Alternatively, the retailer may be given the option to select a product to be associated with the second POS rebate. The product may be from the same or a different manufacturer, allowing the retailer the flexibility of creating desirable promotions.

If the consumer accepts the POS rebate, the POS rebate may be issued to the consumer, at 612. The consumer may be instantly credited an amount of the POS rebate in the current purchase, for example, and/or may provided with a physical and/or electronic indication of the POS rebate (e.g., for future use and/or redemption). In some embodiments, the POS rebate may comprise a gift card, and the gift card may be printed, encoded, and/or provided to the consumer. The POS rebate may also or alternatively comprise a discount and/or coupon code, such as a code that may be utilized to receive a discount when checking out at an online retailer's Web site. In some embodiments, the POS rebate may comprise a rebate on one or more services.

In the case that the rebate-related product is a fireplace toolset, for example, the POS rebate may comprise an offer and/or rebate from a local chimney sweep (e.g., that the consumer may select instead of the mail-in rebate on the tool set). According to some embodiments, the POS rebate may comprise a rebate on and/or a free service contract associated with the rebated product. In the case that the consumer purchases a Digital Video Disk (DVD) player and/or recorder, for example, the DVD player may include a manufacturer's mail-in rebate of one hundred dollars ($50). The consumer may, for example, be presented with the option to exchange the mail-in rebate for a free (or reduced price) three-year (3-yr) service plan and/or extended warranty for the DVD player. Such an exchange may be particularly attractive to retailers, as such service plans are typically associated with very high mark-ups, providing enhanced margins to the retailer.

In some embodiments, the method 600 may continue to prevent redemption of the mail-in and/or manufacturer rebate, at 614. The consumer may surrender a document associated with the mail-in rebate to a retail store clerk and/or POS machine, for example, and/or may simply forgo receiving such a document from the retailer and/or POS (e.g., such as would normally be printed on a product receipt). A printer associated with the POS may be instructed, for example, not to print an indicia of the manufacturer and/or mail-in rebate, and/or may be further instructed to print an indicia of the POS rebate instead. In some embodiments, the scanning of a bar code and/or other indication of the POS rebate may cause a POS printer to perform in such a manner. Upon the consumer accepting the rebate exchange, for example, a retail clerk may scan a barcode and/or enter a value associated with the POS rebate, causing the printer at the POS to produce a product receipt and/or other document that (i) does not indicate the mail-in rebate, (ii) indicates the POS rebate, (iii) indicates that the mail-in rebate is invalid and/or void, and/or (iv) indicates that the mail-in rebate has been exchanged for the POS rebate.

According to some embodiments, a record may be created and/or edited in a database that indicates that the consumer has exchanged the rebates. In the case that the consumer may be uniquely identified, such as via a frequent shopper or credit card number, for example, the database record may reflect that the particular consumer has forgone the opportunity to utilize the mail-in rebate. Such information may either be accessible to the manufacturer or third-party rebate processor, for example, and/or may be provided to the manufacturer and/or processor, so that any attempts to redeem the mail-in rebate by the particular consumer may be identified as inappropriate. In some embodiments, such a database record may be also or alternatively associated with the particular product purchased. A unique identifier such as a Media Access Control (MAC) address and/or a serial number associated with a particular product purchased, for example, may be utilized to flag that particular product as not being qualified to be associated with the mail-in rebate.

According to some embodiments, a document associated with the mail-in and/or manufacturer rebate may be altered to prevent and/or substantially prevent redemption. Once the consumer accepts the rebate exchange, for example, a retail store clerk and/or POS device may (i) stamp and/or print an invalidating indicia on the document, (ii) engrave and/or mark the document, (iii) remove a portion of the document (e.g., by hole-punching, scratching-off, tearing-off a piece, ripping, and/or cutting or shredding), and/or (iv) otherwise alter the document or information stored thereon or therein (electrically, magnetically, etc.). The document may comprise, for example, a mail-in rebate coupon, a receipt, an e-mail printout, a manufacturer and/or other gift or rebate card, and/or a portion of the product and/or packaging thereof (e.g., a “proof of purchase” portion of a box). In some embodiments, the document and/or another indicia of the mail-in rebate may simply be erased, discarded, invalidated (e.g., in a database), and/or destroyed.

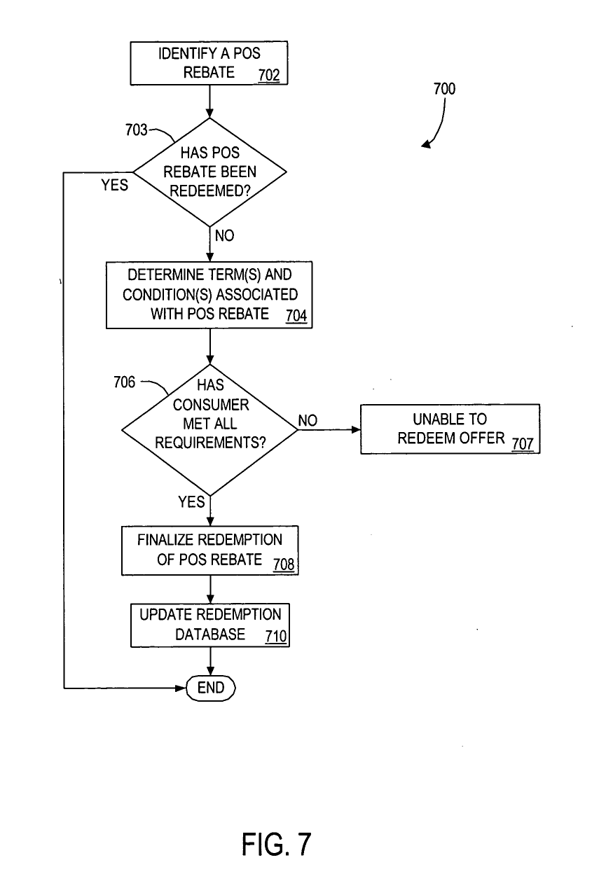

In some embodiments, the method 600 may then end and/or complete and processing may continue to FIG. 7 where the POS rebate is redeemed. The redemption process may be performed during the same transaction (e.g., during the same transaction and at the same terminal where the POS offer was issued), during several different transactions (e.g., the consumer may receive the POS rebate value at a POS terminal and complete the redemption process at a later time), and/or during a later transaction (e.g., the consumer may redeem the POS rebate from a home computer over the Internet). These and other alternative redemption processes are described in conjunction with FIG. 7.

B. POS Rebate Redemption

According to embodiments, POS rebates that have been issued to consumers (e.g., via the method 600 of FIG. 6) may be redeemed in a variety of ways. In some embodiments, the POS rebate may be redeemed in the same transaction in which it is issued (e.g., a method 700 of FIG. 7 is performed in the same transaction as the method 600 of FIG. 6). As an example, if the POS rebate is for a cash payout, a reduction in the purchase price at the POS, or an alternative product offer (as indicated by the POS rebate term(s) and condition(s) in fields 312 and 314 of FIG. 3), the POS rebate is issued and redeemed at the same time by issuing the POS rebate and paying the rebate amount to the consumer, reducing the purchase price at the POS, or giving the consumer an alternative product in the same transaction.

In other embodiments, the POS rebate is redeemed some time after the POS rebate has been issued (e.g., the method 700 of FIG. 7 is performed some time after completion of the method 600 of FIG. 6). For example, some POS rebates may be redeemed by a consumer from a home computer, e.g., over the Internet. As another example, if the POS rebate is for a store credit valued at eighty percent (80%) of the mail-in rebate amount (again, as indicated by the POS rebate term(s) and condition(s) in fields 312 and 314 of FIG. 3) the issuance may involve printing a POS rebate voucher and offering or otherwise presenting it to the consumer. The terms and conditions of the POS rebate may specify that the store credit can only be used in connection with a future purchase; that is, the consumer can only redeem the voucher in a subsequent transaction. These and other redemption processes will now be described by reference to FIG. 7.

One embodiment of a redemption process 700 is depicted in FIG. 7. Redemption of a POS rebate may first involve the identification of the POS rebate, at 702. In one embodiment, this is performed by inputting an offer identifier (field 502 of FIG. 5) that identifies a specific POS rebate that has been issued. The offer identifier may be input by, for example: scanning the POS rebate at a POS device (e.g., where the offer identifier is printed in alphanumeric characters or in a bar code on a receipt or coupon), typing in the offer identifier at a POS device or at a computer connected to the Internet. Alternatively, specific POS rebates may be identified by identifying the particular consumer (e.g., by reference to the consumer's credit card number, driver's license number, or the like) and/or the specific product associated therewith (e.g., via a MAC address and/or serial number).

In embodiments where the POS rebate is redeemed some time after the POS rebate is issued, the identification of the POS rebate may also include an optional process of identifying the consumer. For example, the redemption database 224 (item 500 of FIG. 5) may include consumer identification information (field 504) to match the issued POS rebate to the corresponding consumer. A credit card number, driver's license number, frequent shopper number, Personal Identification Number (PIN) or other identifier system may be utilized to identify consumers and reduce the likelihood of unauthorized rebate redemption.

As a further alternative, identification of the offer and/or the consumer may be performed by reading a transaction card which has recorded the terms and conditions of an issued POS rebate. In one embodiment, the transaction card contains a magnetic strip, integrated circuit, or other recording medium to record the terms and conditions of the POS rebate on the card itself. The card is then read, at 702, to begin the redemption process. The transaction card provides a way of accumulating credits on a single medium, instead of having separate credits issued for each POS rebate. Similarly, where the consumer has a frequent shopper card and, e.g., has registered this as a consumer identifier (field 402 of FIG. 4), the credits may be stored in an account associated with the frequent shopper card.

In other embodiments, e.g., where the POS offer is both issued and redeemed in the same transaction at, e.g., a POS device, the offer identifier (field 502 of FIG. 5) may already have been identified by the POS device (e.g., is stored in temporary memory of the POS device).

The offer identifier is used to retrieve information from the redemption database 500, including the redemption date 514 to determine whether the POS rebate has already been redeemed (at 703). This is an optional step for embodiments where the POS offer is both issued and redeemed in the same transaction. If the POS rebate has already been redeemed (e.g., the redemption date 514 is populated with a date that has past), the redemption process 700 ends and redemption is denied.

If the POS rebate identified by the offer identifier has not previously been redeemed, the procedure continues to 704 where the terms and conditions of the POS rebate are determined. These terms and conditions are retrieved from fields 508 and 510 of the redemption database 224 (table 500 of FIG. 5), and define the POS rebate as well as the steps that must be taken to redeem the offer. For example, a consumer identified by consumer identifier “111-222-333” (from field 504 of table 500) may have a POS rebate “11-22-33” (field 502 of table 500) which has a value of “$40.00” (field 508 of table 500). In order to redeem this offer, the consumer must comply with certain conditions—the “$40.00” can only be used as a “Retailer Credit” and the offer must be redeemed prior to “Jun. 1, 1999” (from field 510 of table 500).

Once the terms and conditions of the POS rebate have been identified, the procedure continues to 706, where the system determines whether the consumer has complied with all requirements to redeem the POS rebate. In the example of the offer identified by offer identifier “11-22-33”, the system must determine if the expiration date of “Jun. 1, 1999” has passed and also if the POS rebate is being presented for redemption in a situation in which a “Store Credit” can be granted (e.g., is the POS rebate being presented at a participating “Electro” retailer?). If these redemption conditions are not met, the process terminates and the consumer is unable to redeem the POS rebate at this time, at 707. The consumer may be reminded of the terms and conditions of the POS rebate, and may be told why the rebate was unable to be redeemed (e.g., the rebate has expired, or the rebate must be presented at a particular retailer for a store credit, etc.). Further, if the POS rebate has expired, a consolation POS rebate may be made in an effort to maintain the good will of the consumer, or the consumer may be allowed to redeem the offer but may be penalized in future transactions.

A number of other terms and conditions can be checked at this stage. For example, if a mail-in rebate is contained in the packaging of a product, it is preferable to allow the consumer to surrender the original mail-in rebate when they return to the store to use the value of the credit, thereby obviating the need to open the package in the store. Thus, one redemption condition might be that the original rebate certificate has been surrendered. Alternatively, or in addition, the manufacturer may require a consumer to contact a manufacturer (e.g., go to a manufacturer's Web site) and input an identifier of the product and/or original manufacturer rebate. Registration via a manufacturer's (or retailer's) Interactive Voice Response Unit (IVRU) is also possible. The operator may then mark a data flag in the redemption database 224 (FIG. 2) to indicate that the redemption condition has been satisfied (or by otherwise removing that particular redemption condition), thereby indicating that the manufacturer rebate certificate has been effectively surrendered for further processing (and/or otherwise prevented from being redeemed, as described herein). Thus, the original manufacturer rebate would be voided, and even if the manufacturer receives it, it would not be honored. This significantly reduces duplicate rebate redemptions.

In embodiments where the consumer has been given the choice of being able to immediately receive the value of the POS rebate (e.g., by receiving a discount at the POS, by receiving cash back at the POS, etc.) and the consumer has agreed to complete certain conditions to complete the redemption process, the consumer's compliance with those conditions is checked at this point. In certain embodiments, the consumer is required to secure the commitment by providing a credit or debit card account number and by authorizing a penalty amount to be charged to the account if the consumer fails to complete the required conditions to complete the redemption process. This embodiment is particularly useful where the manufacturer rebate is contained in the packaging of a product that cannot be opened at the POS. In such an embodiment, if it is determined at 706 that the consumer did not fully complete the redemption process (e.g., did not surrender the manufacturer coupon, etc.), the central controller 102 may levy a penalty against the consumer at this time, e.g., by charging an agreed-upon amount to the consumer's credit card account.

Other conditions may be checked as well. For example, another condition may be that the POS rebate is only valid towards the purchase of a predetermined product or products. Thus, at the time of POS rebate redemption, the terminal 108 and/or the central controller 102 (FIG. 1) may determine whether the predetermined product(s) has been presented for purchase. Alternatively, the consumer may be presented with the choice of yet another POS rebate to be determined during the second transaction. The consumer may be granted the POS rebate having the higher value conditioned upon the purchase of another product by the manufacturer during the later transaction.

If the consumer has met all requirements for redemption of the POS rebate, the redemption process continues to 708 where the POS rebate is redeemed pursuant to the terms and conditions of the offer. For example, regarding the offer identified by offer identifier “11-22-33”, the offer will be redeemed by giving consumer “111-222-333” an Electro store credit of “$40.00”. Upon redemption, redemption database 224 is updated (at 710) to reflect the redemption date (field 514 of FIG. 5). Once redeemed, a POS rebate cannot be redeemed again. This completes the redemption process 700.

A number of variations of the redemption process may be used. For example, the terms and conditions of the offer may specify that the value of a POS rebate will increase, for example, over time, or each time a consumer makes purchases without utilizing an issued POS rebate credit. For example, if a consumer is given a fifty-dollar ($50) POS rebate for the purchase of a given product or products, its value may later increase under certain conditions. For instance, the credit value increases, say, to sixty dollars ($60) if the consumer waits one month (or, alternatively, a number of visits) before using the POS-issued credit. Alternatively, the value of the POS rebate may increase to sixty dollars ($60) if the consumer has made two purchases of at least fifty dollars ($50) without utilizing the issued POS rebate credit. Thus, the redemption parameter for such a POS rebate would be updated to indicate the number of visits, or the amounts of purchases, and/or whether this particular condition has been satisfied. The value of the rebate may also increase based on redemption statistics for a particular type of offer (e.g., if the redemption rate for a particular type of offer is very low, the value may increase for those consumers who actually redeem the offer), or based on other statistics.

In accordance with some embodiments, the POS rebate may be modified after it has been issued, as described above. For example, the POS rebate may be made more attractive, in order to motivate further purchases. Thus, a consumer may have been issued a POS rebate with or without certain associated redemption conditions; that is, at the time of issuance of the POS rebate, the consumer may be informed of any redemption parameters. Upon redemption, the consumer may then be presented with further POS rebates having higher values conditioned upon, e.g., the purchase of a predetermined product, or a total purchase amount higher than a threshold, such as two hundred dollars ($200.00).

The POS rebates issued in accordance with the above description may also be redeemed at other retail establishments. Such establishments may be predefined by the original retailer, and may include other establishments in an affinity group, for example. The value of the POS rebate may decrease if a consumer strays from the issuer of the POS rebate. The use of the issued POS rebate may be determined by certain conditions, such as other promotional offers, excess inventory, or calculated equivalency for the amount of the product. A value would be calculated based on an amount of credit from the original retailer as used at the second retailer. The value may be less than the original. For example, a fifty-dollar ($50) credit at a first store may be worth twenty dollars ($20) at a second store. The first store would then compensate the second store for an amount of money, preferably no more than twenty dollars ($20). Alternatively, the value of an issued POS rebate may stay the same if the consumer decides to purchase another product made by the manufacturer that issued the original POS rebate, regardless of the retailer that makes the sale.

In accordance with some embodiments, the consumer may be informed of the consumer's current POS rebate status, and any updated offers or conditions. The information may be provided to the consumer, for example by way of a Web site where the consumer can log in and check a POS credit account, by way of a kiosk in the retail establishment where the consumer can either log in, scan and/or input an identifier the POS rebate credit or transaction card, or by way of e-mail notification.

C. POS Rebate Updating

The manufacturer conventionally determines the terms and conditions of manufacturer rebates associated with its products, including the value of the rebate. These offers may be, for example, distributed with the packaging of the associated product. According to some embodiments herein, the manufacturer also establishes the terms and conditions of the POS rebate and makes this information accessible to retailers. For example, referring to FIG. 1, the POS rebates and information may be accessed and stored by the central controller 102 and/or terminals 108, 110, 112. Central controller 102 may access manufacturer and POS rebate information from manufacturer server 105 and store it so that it can be accessed by terminals 108, 110, 112.

The central controller 102 records the information in the rebate database 420. Alternatively, the terminals 108, 110, and 112 may query the manufacturer server 105. In these two embodiments, the manufacturer has direct control over the terms and conditions of a POS rebate throughout the promotional period. Central controller 102 and terminals 108, 110, 112 may communicate with a plurality of manufacturer servers 105. In an Internet embodiment, central controller 102 may comprise a Web server, and terminals 108, 110, 112 may comprise personal computers, kiosks, Personal Digital Assistant (PDA) devices, or any other input/output devices able to communicate over a network. Web servers and/or terminals may communicate with manufacturer servers in order to access information regarding manufacturer and POS rebates.

In one embodiment, the terms and conditions of POS rebates are dynamically updated. For example, the manufacturer can monitor redemption statistics, and the associated total cost of the rebate promotion, and responsively adjust the value of a POS rebate. These adjustments can be performed by supplying updated terms and conditions of the POS rebate to the rebate database 420 in a number of ways, for example updates may be provided: on a periodic basis, e.g., daily or weekly, after a certain number of rebates have been redeemed, or in response to the actual redemption statistics. The update may be performed according to the manufacturer's required breakage rate (non-redemption rate).

For example, a manufacturer may predict that seventy-five percent (75%) of all on hundred dollar ($100) manufacturer rebates will be redeemed (e.g., the manufacturer expects to pay out seventy-five dollars ($75) per one hundred dollar ($100) manufacturer rebate, assuming that one-quarter (0.25) of issued rebates will never be redeemed). The manufacturer may initially set the value of a POS rebate at seventy-five dollars ($75), which means that a retailer may offer a consumer a POS rebate of seventy-five dollars ($75) in exchange for each one hundred dollar ($100) manufacturer rebate. If the manufacturer receives a substantial number of manufacturer rebates and is thus paying the full one hundred dollars ($100) to consumers, the manufacturer may decide to lower the value of the POS rebate. For example, the manufacturer may lower the value of the POS rebate to fifty dollars ($50), in order to maintain an average payout of seventy-five dollars ($75) per one hundred dollar ($100) issued manufacturer rebate. Alternatively, the manufacturer may decide to increase the value of a POS rebate to increase consumer acceptance of the POS rebate, and lower manufacturer rebate acceptance/redemption. Conversely, if consumers are redeeming low numbers of manufacturer rebates, the manufacturer may offer ninety dollars ($90) as a POS rebate. The value of POS rebates may be recalculated periodically, such as daily or weekly, or may be performed after a certain number of rebates have actually been processed.

In addition, or alternatively, the manufacturer may adjust the POS rebate by varying the conditions associated with the POS rebates. For example, partway through a promotion, the manufacturer may restrict the redemption of the POS rebate to apply only towards purchases of products made by a specific manufacturer(s), or may limit the time within which the rebate may be redeemed. The conditions can also be removed, or made easier to satisfy, such as by extending the time period for redemption.

The central controller 102 preferably records all accepted and/or rejected POS rebates in the database 104, and more particularly in redemption database 224. The data may then be analyzed to determine more efficient ways to ensure a higher acceptance rate. For example, when offers exhibit a low acceptance rate, the value of POS rebates may increase.

D. Retailer Compensation

In accordance with some embodiments, the method (e.g., the methods 600, 700 described herein) further includes determining a retailer reimbursement value to be credited to the retailer. In this manner, the cost of the POS rebate program may be distributed between the manufacturer and the retailer. In one embodiment, the manufacturer absorbs the full amount of all issued POS rebate credits. That is, the manufacturer compensates the retailer for all POS rebates issued. The manufacturer may pay the retailer a bulk amount for each POS rebate for which the retailer issues credit (e.g. the total value of all issued POS rebates). In this embodiment, the redemption database 224 would be queried periodically (daily, weekly, monthly, etc.) to determine the value of all issued POS rebates per manufacturer. Based on the total value, each manufacturer would then determine the retailer reimbursement value to be credited to the retailer. For example, if a retailer issued three hundred dollars ($300) worth of POS rebates in a week, the manufacturer would credit the retailer reimbursement value of three hundred dollars ($300).

In another embodiment, the retailer is only reimbursed for the value of POS rebates that are actually redeemed by consumers (e.g. the manufacturer pays per redemption of store credit by consumers). For example, if a retailer issued three hundred dollars ($300) worth of POS rebates in one day, the manufacturer would not credit the retailer. If the retailer informs the manufacturer two weeks later that consumers redeemed one hundred dollars ($100) dollars of POS rebates since the issue date, the manufacturer credits the retailer for the one hundred dollars ($100). Such information may be derived from the redemption database 224.

In another embodiment, as mentioned above, the manufacturer may compensate the retailer based on a percentage of the value of issued POS rebates, rather than the full amount. This percentage may be calculated without regard to the actual credit redemption statistics.

E. “Mystery” Rebate Values

In some embodiments, the value of either or both of the manufacturer/mail-in rebate and the POS rebate may be unknown to the consumer at various times. The consumer may be aware of the value of the manufacturer and/or mail-in rebate that is available, for example, and may presented with an option to exchange that rebate for a POS rebate of a “mystery” value. The “mystery” POS rebate may, for example, be an instant rebate applicable to the purchase of the rebate product, such that the consumer may be willing to accept an instant rebate of an unknown value in exchange for the guaranteed value of the cumbersome (e.g., required to mail it in, such as with a proof of purchase) mail-in rebate. In some embodiments, once the consumer accepts the exchange, the value of the POS rebate may be revealed to the consumer. According to some embodiments, the value may be predetermined (e.g., by the POS, retailer, and/or manufacturer) and yet kept secret from the consumer until acceptance. In some embodiments, the POS rebate value may be determined dynamically and/or randomly, upon initiation of the sale at the POS and/or upon an indication of acceptance of the exchange by the consumer.

According to some embodiments, the value of the manufacturer rebate may also or alternatively be unknown to the consumer. The value of the mail-in rebate may be hidden under a latex and/or other scratch layer of a document, such as a mail-in rebate coupon attached to a product, for example, and may only be revealed upon removal of at least a portion of the scratch layer. The consumer may be presented with an option to accept a POS rebate of a certain value, for example, in exchange for a mail-in rebate of unknown value. In one embodiment, the manufacturer rebate may be void if scratched off and/or is scratched off by a method and/or device other than an approved method or device, such as may be only capable (and/or kept secret) by the retailer. In some embodiments, the manufacturer rebate document may comprise a scratch area (or more than one scratch area). Only one scratch area may be removed, for example, to reveal one of many possible rebate values, all of which may be void if more than one area is scratched off.

According to some embodiments, the scratch off area of the manufacturer and/or mail-in rebate document may reveal the value and/or conditions of the POS rebate that is available. The retailer (and/or the consumer, monitored by the retailer, for example) may scratch off the manufacturer rebate to reveal the POS rebate value. This may be performed, for example, after the consumer accepts the exchange, with the removal of the scratch area voiding the mail-in rebate.

It should be understood that the programs, processes, methods and apparatus described herein are not related or limited to any particular type of computer or network apparatus (hardware or software), unless indicated otherwise. Various types of general purpose or specialized computer apparatus may be used with or perform operations in accordance with the teachings described herein. The system may utilize wireless communication systems, and involve portable handheld devices.

Preferred embodiments of have been described herein. It is to be understood, of course, that changes and modifications may be made in the embodiments without departing from the true scope of the present invention, as defined by the appended claims. In view of the wide variety of embodiments to which the principles of the present invention can be applied, it should be understood that the illustrated embodiments are exemplary only, and should not be taken as limiting the scope of some embodiments. For example, the steps of the flow diagrams may be taken in sequences other than those described, and more or fewer elements in various arrangements may be used in the block diagrams.

It should be understood that a hardware embodiment may take a variety of different forms. The hardware may be implemented as an integrated circuit with custom gate arrays or an Application Specific Integrated Circuit (ASIC). Of course, the embodiment may also be implemented with discrete hardware components and circuitry.

V. Rules of Interpretation

Numerous embodiments are described in this patent application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments of the invention nor a listing of features of the invention that must be present in all embodiments.

Neither the Title (set forth at the beginning of the first page of this patent application) nor the Abstract (set forth at the end of this patent application) is to be taken as limiting in any way as the scope of the disclosed invention(s). The term “product” means any machine, manufacture and/or composition of matter as contemplated by 35 U.S.C. §101, unless expressly specified otherwise.

The terms “an embodiment”, “embodiment”, “embodiments”, “the embodiment”, “the embodiments”, “one or more embodiments”, “some embodiments”, “one embodiment” and the like mean “one or more (but not all) disclosed embodiments”, unless expressly specified otherwise.

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “plurality” means “two or more”, unless expressly specified otherwise.

The term “herein” means “in the present application, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase at least one of a widget, a car and a wheel means either (i) a widget, (ii) a car, (iii) a wheel, (iv) a widget and a car, (v) a widget and a wheel, (vi) a car and a wheel, or (vii) a widget, a car and a wheel.

The phrase “based on” does not mean “based only on”, unless expressly specified otherwise. In other words, the phrase “based on” describes both “based only on” and “based at least on”.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

Each process (whether called a method, algorithm or otherwise) inherently includes one or more steps, and therefore all references to a “step” or “steps” of a process have an inherent antecedent basis in the mere recitation of the term ‘process’ or a like term. Accordingly, any reference in a claim to a ‘step’ or ‘steps’ of a process has sufficient antecedent basis.

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device or article is described herein, more than one device or article (whether or not they cooperate) may alternatively be used in place of the single device or article that is described. Accordingly, the functionality that is described as being possessed by a device may alternatively be possessed by more than one device or article (whether or not they cooperate).

Similarly, where more than one device or article is described herein (whether or not they cooperate), a single device or article may alternatively be used in place of the more than one device or article that is described. For example, a plurality of computer-based devices may be substituted with a single computer-based device. Accordingly, the various functionality that is described as being possessed by more than one device or article may alternatively be possessed by a single device or article.

The functionality and/or the features of a single device that is described may be alternatively embodied by one or more other devices that are described but are not explicitly described as having such functionality and/or features. Thus, other embodiments need not include the described device itself, but rather can include the one or more other devices which would, in those other embodiments, have such functionality and/or features.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not indicate that all or even any of the steps are essential or required. Various other embodiments within the scope of the described invention(s) include other processes that omit some or all of the described steps. Unless otherwise specified explicitly, no step is essential or required.

Although a product may be described as including a plurality of components, aspects, qualities, characteristics and/or features, that does not indicate that all of the plurality are essential or required. Various other embodiments within the scope of the described invention(s) include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

Headings of sections provided in this patent application and the title of this patent application are for convenience only, and are not to be taken as limiting the disclosure in any way.

“Determining” something can be performed in a variety of manners and therefore the term “determining” (and like terms) includes calculating, computing, deriving, looking up (e.g., in a table, database or data structure), ascertaining and the like.

It will be readily apparent that the various methods and algorithms described herein may be implemented by, e.g., appropriately programmed general purpose computers and computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer readable media) in a number of manners. In some embodiments, hard-wired circuitry or custom hardware may be used in place of, or in combination with, software instructions for implementation of the processes of various embodiments. Thus, embodiments are not limited to any specific combination of hardware and software A “processor” means any one or more microprocessors, CPU devices, computing devices, microcontrollers, digital signal processors, or like devices.

The term “computer-readable medium” refers to any medium that participates in providing data (e.g., instructions) that may be read by a computer, a processor or a like device. Such a medium may take many forms, including but not limited to, non-volatile media, volatile media, and transmission media. Non-volatile media include, for example, optical or magnetic disks and other persistent memory. Volatile media include DRAM, which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during RF and IR data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth™, TDMA, CDMA, 3G.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device that accesses data in such a database.

The present invention can be configured to work in a network environment including a computer that is in communication, via a communications network, with one or more devices. The computer may communicate with the devices directly or indirectly, via a wired or wireless medium such as the Internet, LAN, WAN or Ethernet, Token Ring, or via any appropriate communications means or combination of communications means. Each of the devices may comprise computers, such as those based on the Intel® Pentium® or Centrino™ processor, that are adapted to communicate with the computer. Any number and type of machines may be in communication with the computer.

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. Applicants intend to file additional applications to pursue patents for subject matter that has been disclosed and enabled but not claimed in the present application.

What is claimed is:

1. A method, comprising:
identifying a product associated with a first rebate, the first rebate being redeemable by mailing a predetermined document associated with the first rebate to a first entity associated with the product;
determining whether a second rebate is associated with the product, wherein the second rebate is not identified by the predetermined document associated with the first rebate;
offering, in the case that the second rebate is determined to be associated with the product, the second rebate to a consumer in exchange for the first rebate; and
issuing the second rebate to the consumer in exchange for the first rebate.

2. The method of claim 1, further comprising:
obtaining the predetermined document, surrendered by the consumer at a retailer terminal operated by a second entity, such that the consumer can no longer redeem the first rebate by mailing the predetermined document to the first entity.

3. The method of claim 1, further comprising:
altering the predetermined document to indicate that the first rebate is no longer valid.

4. The method of claim 3, wherein the altering comprises at least one of: (i) printing an indication on the predetermined document; (ii) engraving an indication into the predetermined document; (iii) removing a portion of the predetermined document; and (iv) attaching an indication to the predetermined document.

5. The method of claim 1, further comprising:
altering the predetermined document to indicate that the first rebate was exchanged for the second rebate.

6. The method of claim 1, wherein the predetermined document comprises a portion of a receipt for a purchase of the product, further comprising:
providing the predetermined document to the consumer.

7. The method of claim 1, wherein the predetermined document comprises a portion of a receipt for a purchase of the product, further comprising:
providing the receipt for the purchase of the product to the consumer, wherein the receipt does not include the portion defining the predetermined document.

8. The method of claim 1, wherein the first rebate is a manufacturer rebate and the second rebate is a point-of-sale rebate.

9. The method of claim 1, further comprising:
receiving an indication of an acceptance of the second rebate from the consumer.

10. The method of claim 1, further comprising:
redeeming the second rebate for compensation, the compensation including at least one of: (i) an alternative product; (ii) a retailer credit; (iii) a price reduction; (iv) a coupon; (v) a certificate; and (vi) cash.

11. The method of claim 10, wherein the offering and the redeeming are performed at the same terminal.

12. The method of claim 10, wherein the redeeming further includes at least one of: (i) issuing an amount of credit; (ii) crediting an amount to an account; and (iii) recording an amount of credit on a transaction card.

13. The method of claim 1, wherein the identifying of the product associated with the first rebate comprises:
comparing an indicia provided by the consumer to a cross-reference of stored indicia and associated products.

14. The method of claim 1, wherein the determining of whether the second rebate is associated with the product comprises:
querying a database storing a cross-reference of products and associated rebates.

15. The method of claim 1, wherein the issuing of the second rebate to the consumer in exchange for the first rebate comprises:
collecting the predetermined document associated with the first rebate from the consumer; and
providing an indication of the second rebate to the consumer.

16. The method of claim 1, wherein the issuing of the second rebate to the consumer in exchange for the first rebate comprises:
altering the predetermined document associated with the first rebate to indicate that the first rebate in no longer valid; and
providing an indication of the second rebate to the consumer.

17. A method of processing rebates, comprising:
identifying a first rebate associated with a product, the first rebate being redeemable by mailing a predetermined document associated with the first rebate to a first entity associated with the product;
determining whether an alternative rebate is associated with the product, wherein the alternative rebate is not identified by the predetermined document associated with the first rebate;
accepting, in the case that the alternative rebate is determined to be associated with the product, input indicative of a selection of the alternative rebate; and
issuing the alternative rebate to the consumer in exchange for the first rebate.

18. The method of claim 17, further comprising:
obtaining the predetermined document, surrendered by the consumer at a retailer terminal operated by a second entity, such that the consumer can no longer redeem the first rebate by mailing the predetermined document to the first entity.

19. The method of claim 17, further comprising:
altering the predetermined document to indicate that the first rebate is no longer valid.

20. The method of claim 19, wherein the altering comprises at least one of: (i) printing an indication on the predetermined document; (ii) engraving an indication into the predetermined document; (iii) removing a portion of the predetermined document; and (iv) attaching an indication to the predetermined document.

21. The method of claim 17, further comprising:
altering the predetermined document to indicate that the first rebate was exchanged for the second rebate.

22. A document indicative of a manufacturer rebate, comprising:
an indication of a product for which a manufacturer rebate applies; and
an indication, provided by a retailer, that the manufacturer rebate is not valid.

23. The document of claim 22, further comprising:
an indication of a time period during which the manufacturer rebate is typically valid.

24. The document of claim 22, further comprising:
an indication that an alternative point-of-sale rebate was accepted by a consumer in exchange for the manufacturer rebate.

25. The document of claim 22, wherein the retailer-provided indication that the manufacturer rebate is not valid comprises at least one of: (i) a printed indication; (ii) an engraved indication; (iii) a removal of a portion of the document; and (iv) an attachment to the document.
